(19) United States
(12) Patent Application Publication
(10) Pub. No.: US 2023/0150166 A1
(43) Pub. Date: May 18, 2023

(54) METHOD FOR TREATING A WOOD SUBSTRATE

(71) Applicant: Koppers Performance Chemicals, Inc., Pittsburgh, PA (US)

(72) Inventors: Jun Zhang, Peachtree City, GA (US); Peter Tham, Morrow, GA (US); Craig Wilson, Guelph (CA)

(21) Appl. No.: 17/526,526

(22) Filed: Nov. 15, 2021

(51) Int. Cl. B27K 3/22

(52) U.S. Cl. CPC B27K 3/22; B27K 2240/20

(57) ABSTRACT

A method for treating a wood substrate is provided. The method comprises contacting the wood substrate in a field application with an aqueous composition. The contacting is performed at a pressure of less than 20 psia. The aqueous composition comprises, by total weight of the aqueous composition, 1.0% to 10.0% by weight of a micronized basic copper carbonate, 0.35% to 2.5% by weight of a quaternary ammonium compound, and at least 80% by weight of water.

### FIELD

The present disclosure relates to a method for treating a wood substrate.

### BACKGROUND

Pressure treated wood is typically manufactured at large manufacturing facilities by obtaining or cutting lumber in predetermined nominal sizes (e.g., 2″×4″×8′, 2″×6″×8′, 2″×8″×8′, 4″×4″×8′,1″×6″×8′, etc.), applying the treatment through a vacuum/pressure treating process, and, thereafter, transporting the finished product to a job site for use. At the job site, the pressure treated wood is used in various projects that may require modification of the wood. For example, the pressure treated wood can be cut into different sizes or configurations, drilled to have a hole, or other modifications, that may expose interior untreated portions of the pressure treated wood that may render the wood more susceptible to fungal decay and/or insect attack than an uncut exterior portion. After pressure treatment, some difficult-to-treat wood species, such as Douglas fir, Hem fir, red cedar, spruce-pine-fir (SPF), or pines including southern pine, red pine and ponderosa pine from certain geographic locations can have interior portion/heartwood area that remain as untreated, and the untreated portion, once exposed, can be more susceptible to fungal decay and/or insect attack. There are challenges with field modifications of pressure treated wood.

### SUMMARY

The present disclosure provides a method for treating a wood substrate. The method comprises contacting the wood substrate in a field application with an aqueous composition. The contacting is performed at a pressure of less than 20 psia. The aqueous composition comprises, by total weight of the aqueous composition, 1.0% to 10.0% by weight of a micronized basic copper carbonate, 0.35% to 2.5% by weight of a quaternary ammonium compound, and at least 80% by weight of water.

The present disclosure also provides a method for treating a wood substrate. The method comprises contacting the wood substrate with an aqueous composition by at least one of brushing and rolling in a field application. The contacting is performed at a pressure in a range of 12 psia to 16 psia. The aqueous composition comprises, by total weight of the aqueous composition 1.8% to 5.0% of a micronized basic copper carbonate, 0.5% to 1.5% of a quaternary ammonium compound, and 85% to 95% of water. The micronized basic copper carbonate has an average particle size in a range of 5 nanometers to 25 microns. The quaternary ammonium compound comprises dimethyldidecyl ammonium chloride, dimethyldidecyl ammonium carbonate, dimethyldidecyl ammonium bicarbonate, benzalkonium chloride, alkyl benzyl ammonium chloride, or a combination thereof. The micronized basic copper carbonate is a solid suspended in the water.

It is understood that the inventions described in this specification are not limited to the examples summarized in this Summary. Various other aspects are described and exemplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 illustrates a schematic diagram of a test substrate used in above ground experiments; and

FIG. 2 illustrates a schematic diagram of a test substrate used in ground contact experiments.

The exemplifications set out herein illustrate certain non-limiting embodiments, in one form, and such exemplifications are not to be construed as limiting the scope of the appended claims in any manner.

### DETAILED DESCRIPTION

Certain exemplary aspects of the present disclosure will now be described to provide an overall understanding of the principles of the structure, function, manufacture, and use of the compositions, methods, and products disclosed herein. One or more examples of these aspects are illustrated in the accompanying drawings. Those of ordinary skill in the art will understand that the devices and methods specifically described herein and illustrated in the accompanying drawings are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Any references herein to “various examples,” “some examples,” “one example,” “an example,” similar references to “aspects,” or the like, means that a particular feature, structure, or characteristic described in connection with the example is included in at least one example. Thus, appearances of the phrases “in various examples,” “in some examples,” “in one example,” “in an example,” similar references to “aspects,” or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

Typically, methods for field application of wood preservatives utilize copper naphthenate containing compositions that can have an undesirable odor, high volatile organic compound (VOC) content, persistence on surfaces (e.g., difficult to clean up), and an undesirable color (e.g., dark green color that does not match the color of most residential preserved wood products). Additional issues with wood preservatives have been discussed in “Evaluation of Nonpressure Wood Preservatives for Military Applications” by Lebow et al. (Available at https://www.fpl.fs.fed.us/documnts/fplrp/fpl_rp693.pdf).

In light of these issues, the present disclosure provides a method for treating a wood substrate comprising contacting the wood substrate in a field application with an aqueous composition and the contacting is performed at a pressure of less than 20 psia. The aqueous composition comprises, by total weight of the aqueous composition, 1.0% to 10.0% by weight of micronized basic copper carbonate, 0.35% to 2.5% by weight of a quaternary ammonium compound, and at least 80% by weight of water.

As used herein, a “field application” is an application in which a wood treatment composition is applied to a wood substrate at a location, such as a job site or “field,” that is not at the facility of origin of the wood substrate; the wood treatment composition is applied in the “field” to a portion of the wood substrate that has been exposed to the environment due to a physical alteration of the pressure treated wood product, such as by cutting or drilling, at or near the time of initial installation of the wood product. The wood substrate may have already been pressure treated at the facility of origin. “Pressure treated” is meant to mean a wood product that is treated with a treatment composition through a vacuum pressure treatment of at least 40 psia, and may be at least 100 psia. Typical pressure treating process can be found in American Wood Protection Association (AWPA) T1 Standard: Processing and Treatment Standard, which is hereby incorporated by reference. For example, the treatment composition can be applied during a residential, commercial, or industrial building project that utilizes pressure treated wood, such as, for example, a deck, a rail, a fence, a utility pole, a railway tie, a railroad bridge, cladding, siding, or a combination thereof. The field application can utilize minimal equipment (e.g., brushes, rollers, sprayers) and offer flexibility in application such that the composition can be applied to one wood substrate at a time or multiple wood substrates at a time. In various examples, the field application can be applied by a single user.

The aqueous composition employed in the method of the present disclosure may comprise a micronized basic copper carbonate, a quaternary ammonium compound, and water. The aqueous composition may also comprise at least one of a colorant, an antifoam, a dispersant, a co-biocide, a water repellant, a wax, a mold inhibitor, a corrosion inhibitor, or a combination thereof. The co-biocide can comprise an azole. In certain examples, the aqueous composition may comprise micronized basic copper carbonate, quaternary ammonium compound, water, optionally a colorant, optionally an antifoam, and optionally a dispersant.

The term “micronized”, as used herein, refers to a solid that has been processed to an average particle size of no greater than 25 microns. Average particle size as used herein refers to the d₅₀ of the compound which is the diameter where 50% by weight of particles have diameters equal to or lower than the d₅₀, while 50% by weight of the particles have a diameter greater than the d₅₀. For a particle size of 0.2 microns or greater, the average particle size can be determined by laser diffraction technique, such as, for example with a LA.960 Laser Diffraction Particle Size Analyzer by Horiba and Co. Ltd., or Mastersizer 3000 manufactured by Malvern Panalytical. Smaller sizes can be determined by a dynamic light scattering method, such as, for example, with a. SZ-100 Dynamic Light Scattering analyzer by Horiba or Zetasizer family by Malvern.

A micronized compound may be a solid that can be dispersed as a suspension into an aqueous carrier. For example, micronized basic copper carbonate can be a solid suspended in water. The micronized basic copper carbonate can have an average particle size of 5 nanometers to 25 microns, such as, for example, 50 nanometers to 5 microns or 100 nanometers to 1 micron.

The aqueous composition can comprise an amount of micronized basic copper carbonate suitable to inhibit decay of a wood substrate and/or insect attack of a wood substrate. For example, the aqueous composition can comprise 1.0% to 10.0% by weight of a micronized basic copper carbonate based on the total weight of the aqueous composition, and may comprise, for example, 1.8% to 5.0% by weight of a micronized basic copper carbonate based on the total weight of the aqueous composition.

The aqueous composition can comprise 0.35% to 2.5% by weight of a quaternary ammonium compound based on the total weight of the aqueous composition, and may comprise, for example, 0.5% to 1.5% by weight of a quaternary ammonium compound based on the total weight of the aqueous composition. The quaternary ammonium compound can provide biocidial activity and as a wetting agent to facilitate spreading of the aqueous composition into the wood substrate. The quaternary ammonium compound can comprise a cationic quaternary ammonium compound and have a general chemical structure as shown in Structure 1:

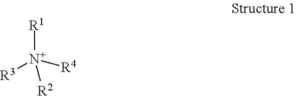

Where the R¹, R², R³ and R⁴ groups may be the same or different alkyl or aryl groups. In various examples, the quaternary ammonium compound can comprise an anionic quaternary ammonium compound. In certain examples, the quaternary ammonium compound can comprise dimethyldidecyl ammonium chloride, dimethyldidecyl ammonium carbonate, dimethyldidecyl ammonium bicarbonate, alkylbenzyl ammonium chloride, benzalkonium chloride, alkyldimethylbenzylammonium chloride, or a combination thereof. In various examples, the quaternary ammonium compound can comprise dimethyldidecyl ammonium chloride, alkyl benzyl ammonium chloride, or a combination thereof.

The aqueous composition can comprise at least 80% by weight of water based on the total weight of the aqueous composition, such as, for example, at least 85% by weight of water, or at least 90% by weight of water based on the total weight of the aqueous composition. The aqueous composition can comprise no greater than 99% by weight of water based on the total weight of the aqueous composition, such as, for example, no greater than 98% by weight of water, or no greater than 95% by weight of water based on the total weight of the aqueous composition. For example, the aqueous composition can comprise 80% to 99% by weight of water, based on the total weight of the aqueous composition, such as, for example, 85% to 95% by weight of water based on the total weight of the aqueous composition. The use of water can increase the ease with handling of the solution and minimize undesirable odors and/or volatile organic compounds.

Contacting the wood substrate in the field application with the aqueous composition may not require complex and/or large equipment and/or a pressure treatment facility. For example, the contacting can be performed after the wood substrate has been pressure treated at a pressure treatment facility and transported to a job site. Thereafter, the wood substrate can be modified at the job site and contacted with the aqueous composition according to the pressure disclosure. Contacting the wood substrate with the aqueous composition can be performed by a surface application method, such as, for example, dipping, soaking, spraying, brushing, rolling, or a combination thereof. In various examples, the contacting the wood substrate with the aqueous composition can be performed by brushing, rolling, or a combination thereof.

The contacting can be performed at ambient conditions typically encountered in a field application at a job site. For example, the contacting can be performed at a pressure of less than 20 pounds per square inch atmospheric (psia), such as, for example, less than 16 psia or less than 15 psia. In various examples, the contacting can be performed at a pressure of greater than 10 psia, such as, for example, greater than 12 psia. For example, the contacting can be performed at a pressure in a range of 10 psia to 20 psia or 12 psia to 16 psia.

The contacting can be performed for a period of time suitable to inhibit fungal decay and/or insect attack (e.g., termite attack) of the wood substrate. For example, the contacting can be performed until the wood retains a desired amount of wood preservative composition. For example, the contacting can be performed by brushing once or twice.

The wood substrate can comprise various wood containing products, such as, for example, timber, plywood, laminated veneer lumber (LVL), cross laminated timber (CTL), parallel strand lumber (PSL), structural glued laminated timber, particle board, dimensional lumber, or a combination thereof. The wood substrate can comprise various wood containing structures, such as, for example, a deck, a rail, a fence, a utility pole, a railway tie, a railroad bridge, cladding, siding, or a combination thereof. The wood substrate can comprise various wood species, such as, for example, Douglas fir, Hem-fir, Nordic pine, Scotts pine, Norway spruce, Sitka spruce, southern yellow pine, red pine, spruce-pine-fir, ponderosa pine, lodgepole pine, incised Douglas fir, incised Hem-fir, or a combination thereof.

### EXAMPLES

The present disclosure will be more fully understood by reference to the following examples, which provide illustrative non-limiting aspects of the invention. It is understood that the invention described in this specification is not necessarily limited to the examples described in this section.

### Above Ground Test Experiments

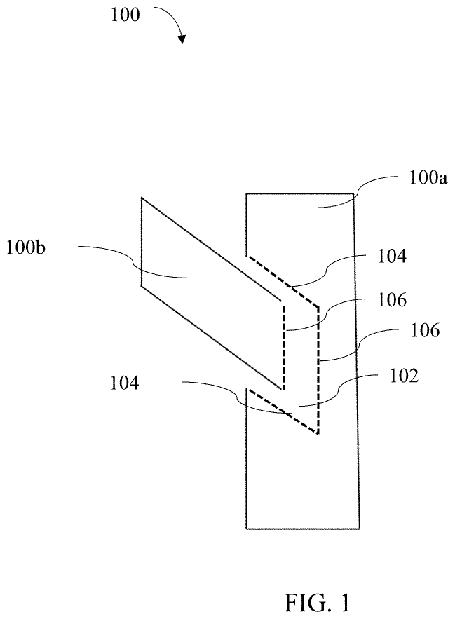

A wood substrate containing western hemlock was pressure treated with chromated copper arsenate type C (CCA-C) preservative at a 1.7% total active solution strength. The total active solution strength can be measured according to AWPA Standard P23. After pressure treatment and air-drying, a first piece 100a and a second piece 100b of the CCA treated western hemlock were cut and formed into a Y-shaped test substrate 100 as illustrated in FIG. 1. To form the test substrate 100, the first piece 100a was cut to 400 mm in length with a side notch and the second piece 100b was cut on a diagonal at 250 mm in length suitable to fit into the side notch. The second piece 100b was placed into the side notch of the first piece 100a to form the Y-shaped test substrate. The configuration of the test substrate 100 provides a water trap 102 as well as exposed generally horizontal surfaces 104 and generally vertical surfaces 106.

Various test substrates 100 were prepared and numbered for evaluation with different wood preservative compositions. The generally horizontal surfaces 104 and the generally vertical surfaces 106 were coated with two applications of one of the wood preservative compositions listed in Table 1 below by brushing the respective wood composition onto the surfaces.

TABLE 1
Field-Cut Brush-on Preservatives for Above Ground Testing

| Wood | |
|---|---|
| Preservative | Description |
| Comparative | Copper Naphthenate containing wood preservative |
| Wood | (2% copper metal by weight in a carrier |
| Preservative 1 | of mineral spirits) |
| Wood | Micronized basic copper carbonate (average particle |
| preservative 2 | size in a range of 200 nm to 400 nm) aqueous |
| | composition according to the present disclosure |
| | (2% copper metal by weight in a carrier of water) |
| Control | No Brush-on preservative treatment |
| Above | |
| Ground | |

Comparative wood preservative 1 had an undesirable odor due to the use of mineral spirits and imparted a dark green color to the wood substrates. It was observed that wood preservative 2 had a better odor than comparative wood preservative 1 and wood preservative 2 was easier to handle and clean up than comparative wood preservative 1.

### Ground Contact Test Experiments

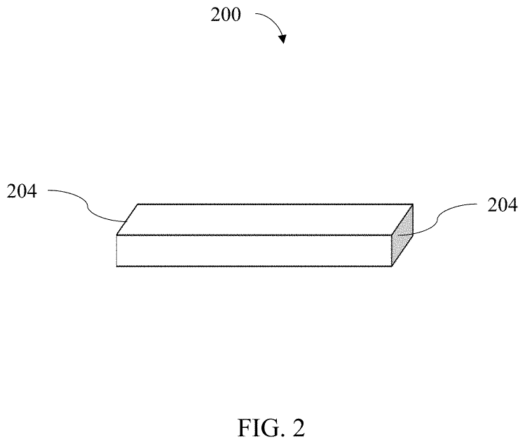

A wood substrate containing western hemlock was pressure treated with CCA-C preservative at 1.7% total active solution strength. After pressure treatment and air-drying, the CCA treated western hemlock was cut into a 250 mm length as illustrated in FIG. 2 to form a test substrate 200. The cut surfaces 204 of the test substrate 200 were coated with two applications of one of the wood preservative compositions listed in Table 2 below by brushing the respective wood composition onto the surfaces.

TABLE 2
Field-Cut Brush-on Preservatives for Ground Contact Testing

| Wood | |
|---|---|
| Preservative | Description |
| Comparative | Copper Naphthenate containing wood preservative |
| Wood | (2% copper metal by weight in a carrier |
| Preservative 1 | of mineral spirits) |
| Comparative | Copper Naphthenate containing wood preservative |
| Wood | (1% copper metal by weight in a carrier |
| Preservative 3 | of mineral spirits) |
| Wood | Micronized basic copper carbonate(average particle |
| Preservative 4 | size in a range of 200 nm to 400 nm) aqueous |
| | composition according to the present disclosure |
| | (2% copper metal by weight in a carrier of |
| | water and 1.25% by weight of dimethyldidecyl |
| | ammonium chloride |
| Control | No Brush-on preservative treatment |
| Ground | |
| Contact | |

After the field application of the respective wood preservative composition, half of the length of each test substrate 200 was buried in a trench and each test substrate 200 was separated by approximately 75 cm from an adjacent test substrate. Soil was put back around the test substrates and a flag was placed to mark each location.

Testing Site

The test site for the above ground test experiments and ground contact test experiments was in Maple Ridge, BC within the University of BC Malcolm Knapp Research Forest. The soil at the test site was a sandy silt loam to a depth of 0.3 m (12 in). The soil has a pH of around 5.1 and is relatively high in organic matter (15-21%). Below a depth of 12 inches, there is a layer of fine- to coarse-grained sand with some gravel and silt. In summer, groundwater is between 0.5 and 2.4 m (20-94 in) below grade and flows in a predominantly southwest direction. The test site has a rainfall of over 2150 mm per year and an average yearly temperature of 9.6° C. with mean daily maximum and minimum temperatures of 6° C. and 1° C. in January, and 23° C. and 12° C. in July. The test site falls within the moderate decay hazard zone for outdoor above-ground exposure using the Scheffer Index with an updated value of 63. This zone includes most of the major population centers of North America. Soil-inhabiting wood-rotting basidiomycetes including Leucogyrophana pinastri (Fries) Ginns & Weresub, Fibroporia vaillantii (DC.) Parmasto, Tapinella sp., and Antrodia serialis have been found on test material sporadically across the entire site.

Inspection of Test Material

For above ground test experiments, the test substrates were inspected for decay on a two-year cycle due to the relatively slow progress of decay above ground. Each specimen was examined visually for indications of decay such as the presence of fungal mycelium or discoloration. If decay was suspected, the area of interest was gently probed with a metal scraper. Each surface that was treated with the wood preservative compositions listed in Table 1 were then assigned a decay rating based on the American Wood Protection Association (AWPA) E7 (2008) grading system as shown in Table 3 below.

TABLE 3
AWPA Rating System

| Decay | | |
|---|---|---|
| Rating | Condition | Description |
| 10 | Sound | No sign or evidence of decay, wood |
| | | softening or discoloration caused |
| | | by microorganism attack. |
| 9.5 | Trace- | Some areas of discoloration and/or |
| | suspect | softening associated with superficial |
| | | microorganism attack. |
| 9 | Slight | Decay and wood softening is present. |
| | attack | Up to 3% of the cross-sectional |
| | | area affected. |
| 8 | Moderate | Similar to “9” but more extensive |
| | attack | attack with 3-10% of the cross-sectional |
| | | area affected. |
| 7 | Moderate/ | Sample has between 10-30% of the cross- |
| | severe attack | sectional area decayed. |
| 6 | Severe | Sample has between 30-50% of the cross- |
| | attack | sectional area decayed. |
| 4 | Very severe | Sample has between 50-75% of the cross- |
| | attack | sectional area decayed. |
| 0 | Failure | Sample has functionally failed. It can |
| | | either be broken by hand due to decay |
| | | or the evaluation probe can penetrate |
| | | through the sample. |

For ground contact test experiments, the test substrates were inspected annually. Each test substrate in ground contact was removed from the soil and loose grass and dirt were brushed off. The test substrates were then examined visually for indications of decay such as the presence of fungal mycelium or discoloration. If decay was suspected, the area of interest was gently probed with a metal scraper. Then each surface that was treated with a wood preservative compositions listed in Table 2 was assigned a decay rating based on the AWPA E7 (2008) grading system as shown in Table 3 above.

Results

The results of the above ground test experiments are summarized in Table 4.

TABLE 4
Results of Above Ground Test Experiments

| Wood Preservative Used | Year | % of Samples Rated <= 9 |
|---|---|---|
| Comparative | 2 | 0 |
| Wood | 4 | 0 |
| Preservative 1 | 6 | 0 |
| | 8 | 0 |
| Wood | 2 | 0 |
| Preservative 2 | 4 | 20 |
| | 6 | 20 |
| | 8 | 20 |
| Control | 2 | 30 |
| Above | 4 | 30 |
| Ground | 6 | 50 |
| | 8 | 60 |

The control demonstrated decay on the field cut surfaces after only two years and the decay worsened thereafter with about 60% of the test substrates having ratings lower than 9.0 after 8 years. Test substrates treated with wood preservative 2 showed no significant decay after 2 years and only minimal decay with about 20% of the test substrates having ratings lower than 9.0 after 8 years.

The results of the ground contact test experiments are summarized in Table 5 below.

TABLE 5
Results of Ground Contact Test Experiments

| | | | | | | | | | % of Samples |
|---|---|---|---|---|---|---|---|---|---|
| Wood | Mean Decay Ratings | | | | | | | | Rated <=9 |
| Preservative Used | 1-yr | 2-yr | 3-yr | 4-yr | 5-yr | 6-yr | 7-yr | 8-yr | after 8 years |
| Comparative Wood | 10 | 10 | 9.8 | 9.8 | 9.8 | 9.8 | 9.8 | 9.8 | 30 |
| Preservative 1 | | | | | | | | | |
| Comparative Wood | 10 | 9.8 | 9.9 | 9.7 | 9.6 | 9.6 | 9.6 | 9.2 | 60 |
| Preservative 3 | | | | | | | | | |
| Wood | 9.9 | 9.7 | 9.3 | 9.4 | 9.0 | 8.7 | 8.6 | 8.5 | 50 |
| Preservative 4 | | | | | | | | | |
| Control | 7.0 | 4.5 | 4.5 | 3.6 | 2.8 | 2.0 | 1.5 | 1.3 | 100 |
| Ground Contact | | | | | | | | | |

After 8 years, the control demonstrated significant decay in the field-cut areas with 100% of test substrates having ratings lower than 9.0 in the ground contact test experiments. The test substrates treated with wood preservative 4 had decreased decay after 1 year comparative to the control and had only about 50% of the test substrates having ratings lower than 9.0 after 8 years. Test substrates treated with comparative wood preservative 3 showed more decay than test substrates treated with wood preservative 4.

The results of the experiments indicate that wood preservatives 2 and 4 can inhibit the fungal decay of wood substrates in a field application. Wood preservatives 2 and 4 exhibit a desirable odor (e.g., lack of an undesirable odor), minimal, if any, volatile organic compound content, ease of clean up, and a desirable color (e.g., lack of an undesirable color). It is believed other aqueous compositions described in the present application used in a field application would also exhibit these properties.

In this specification, unless otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited.

The grammatical articles “a,” “an,” and “the,” as used herein, are intended to include “at least one” or “one or more,” unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure as set forth in this specification supersedes any conflicting material incorporated by reference. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

One skilled in the art will recognize that the herein-described components, devices, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

1. A method for treating a pressure treated wood substrate, the method comprising:
contacting the pressure treated wood substrate in a field application at a time of an initial installation of the pressure treated wood substrate with an aqueous composition by at least one of brushing and rolling, wherein the contacting is performed at a pressure of less than 20 psia, wherein the contacting is performed for a period of time suitable to inhibit fungal decay and insect attack of the pressure treated wood substrate, the aqueous composition comprising, by total weight of the aqueous composition:
1.0% to 10.0% by weight of a micronized basic copper carbonate;
0.35% to 2.5% by weight of a quaternary ammonium compound; and
at least 80% by weight of water.

2. The method of claim 1, wherein the micronized basic copper carbonate has an average particle size of 5 nanometers to 25 microns.

3. The method of claim 1, wherein the micronized basic copper carbonate has an average particle size of 50 nanometers to 5 microns.

4. The method of claim 1, wherein the micronized basic copper carbonate is a solid suspended in the water.

5. The method of claim 1, wherein the contacting is performed at a pressure in a range of 10 psia to 20 psia.

6. The method of claim 1, wherein the contacting is performed at a pressure in a range of 12 psia to 16 psia.

7. The method of claim 1, wherein the contacting is performed at a construction site.

8. (canceled)

9. The method of claim 1, wherein the wood substrate comprises timber, plywood, laminated veneer lumber (LVL), cross laminated timber (CTL), parallel strand lumber (PSL), structural glued laminated timber, particle board, dimensional lumber, or a combination thereof.

10. The method of claim 1, wherein the wood substrate comprises a deck, a rail, a fence, a utility pole, a railway tie, a railroad bridge, cladding, siding, or a combination thereof.

11. The method of claim 1, wherein the wood substrate comprises Douglas fir, Hem-fir, Nordic pine, Scotts pine, Norway spruce, Sitka spruce, southern yellow pine, red pine, spruce-pine-fir, ponderosa pine, lodgepole pine, incised Douglas fir, incised Hem-fir, or a combination thereof.

12. The method of claim 1, wherein the aqueous composition comprises, by total weight of the aqueous composition, 1.8% to 5.0% by weight of micronized basic copper carbonate.

13. The method of claim 1, wherein the aqueous composition comprises, by total weight of the aqueous composition, 0.5% to 1.5% by weight of the quaternary ammonium compound.

14. The method of claim 1, wherein the quaternary ammonium compound comprises dimethyldidecyl ammonium chloride, dimethyldidecyl ammonium carbonate, dimethyldidecyl ammonium bicarbonate, alkylbenzyl ammonium chloride, benzalkonium chloride, alkyldimethylbenzylammonium chloride, or a combination thereof.

15. The method of claim 1, wherein the aqueous composition comprises, by total weight of the aqueous composition, 85% to 95% by weight of the water.

16. The method of claim 1, wherein the aqueous composition further comprises a colorant, an antifoam, a dispersant, a co-biocide, a water repellant, a wax, a mold inhibitor, a corrosion inhibitor, or a combination thereof.

17. The method of claim 16, wherein the aqueous composition further comprises the co-biocide and the co-biocide comprises an azole.

18. The method of claim 1, wherein the aqueous composition consists of the micronized basic copper carbonate, the quaternary ammonium compound, the water, optionally a colorant, optionally an antifoam, and optionally a dispersant.

19. (canceled)

20. A method for treating a pressure treated wood substrate, the method comprising:
physically altering at least a portion of the pressure treated dimensional lumber, thereby forming an exposed portion;
contacting the exposed portion of the pressure treated dimensional lumber with an aqueous composition by at least one of brushing and rolling in a field application, wherein the contacting is performed at a pressure in a range of 12 psia to 16 psia, wherein the contacting is performed for a period of time suitable to inhibit fungal decay and insect attack of the pressure treated dimensional lumber, the aqueous composition consisting of, by total weight of the aqueous composition:
1.8% to 5.0% of a micronized basic copper carbonate that has an average particle size of 5 nanometers to 25 microns;
0.5% to 1.5% of a quaternary ammonium compound comprising dimethyldidecyl ammonium chloride, dimethyldidecyl ammonium carbonate, dimethyldidecyl ammonium bicarbonate, benzalkonium chloride, alkyl benzyl ammonium chloride, or a combination thereof;
85% to 95% of water, wherein the micronized basic copper carbonate is a solid suspended in the water; and
optionally a colorant, an antifoam, a dispersant, a co-biocide, a water repellant, a wax, a mold inhibitor, a corrosion inhibitor, or a combination thereof.

21. The method of claim 1, wherein the aqueous composition does not include a thickener and the aqueous composition is a liquid.
